(19) United States
(12) Patent Application Publication
(10) Pub. No.: US 2017/0037723 A1
(43) Pub. Date: Feb. 9, 2017

(54) Method and Apparatus for Utilizing Optically Clear Fluid for Acquiring Visual Data in Wellbore Environments

(71) Applicant: ABRADO, INC., HOUSTON, TX (US)

(72) Inventors: PHILIP SCHULTZ, KATY, TX (US); MARSHAL HARRIS, HOUSTON, TX (US); BENNY SILGUERO, HOUSTON, TX (US); ALEXANDER ESSLEMONT, HOUSTON, TX (US); JOHN WOLF, SPRING, TX (US)

(73) Assignee: ABRADO, INC., HOUSTON, TX (US)

(21) Appl. No.: 15/303,904

(22) PCT Filed: May 1, 2015
(86) PCT No.: PCT/US15/28895

§ 371 Date: Oct. 13, 2016

Related U.S. Application Data
(60) Provisional application No. 61/986,970, filed on May 1, 2014.

(51) Int. Cl. E21B 47/00; H04N 7/18; E21B 33/12

(52) U.S. Cl. CPC E21B 47/0002; E21B 33/12; H04N 7/185; E21B 34/06

(57) ABSTRACT

A fluid (30) of optically clear composition is used to create a viewing window within a wellbore (1), pipelines, tanks, vessels, or any other similar environment. Selective placement of optically clear fluid facilitates acquisition of visual images and/or other data in particular areas of interest within environments containing opaque or non-transparent fluids. Such optically clear fluid can displace opaque fluids and gases, while maintaining specific viscosity, weight, and other fluid properties in order to keep opaque fluids from encroaching into a viewing area while visual data acquisition is performed.

### BACKGROUND OF THE INVENTION

1. Technical Field of the Invention

The present invention pertains to a method for creating an optically clear environment in which to obtain a plurality of visual images or other data in a variety of environments generally comprising opaque or any other non-transparent fluids, such as, for example, wellbores, pipelines, or any other similar oil and gas industry tubulars. More particularly, the present invention pertains to a method of use of an optically clear fluid or gel that is placed strategically in a localized area of interest where visual data acquisition is desired, but where opaque or non-transparent fluids (such as, for example, hydrocarbon liquids or grease) in such environment would otherwise generally limit or prohibit visual imaging and data capture.

2. Brief Description of the Prior Art

Camera systems exist for use in confined areas such as, for example, within wells and wellbores that penetrate subterranean formations. Generally, said camera systems obtain visual images in the form of still photographs or videos. Such visual images are often beneficial for purposes of diagnosing downhole wellbore problems and/or evaluating the effectiveness of operations conducted within said wellbores. Additionally, downhole camera systems are used for acquiring visual images and other data within wellbores, pipelines, and other tubulars and are useful for a variety of purposes, including, without limitation, inspection of safety valves, subsea and BOP equipment, scale, wellbore integrity, fish/debris orientation, milling and fracking jobs, fluid entry detection, and a manner of other reasons.

Generally, such camera systems are lowered within a wellbore, deployed to a desired location within said wellbore, and thereafter retrieved from said wellbore. Although jointed or continuous pipe or other tubular goods can be used to convey such camera systems in and out of wellbores, it is typically more operationally efficient and cost-effective to utilize flexible wireline or cable to convey such camera systems in such wellbores.

Generally, such wireline can comprise conductive electric line or “e line” that permits the transmission of electrical charges and/or data through said line. Alternatively, said wireline can comprise non-conductive “slickline” that does not permit such transmission of data or electrical charges. Both of these types of wireline can be used to convey camera systems in and out of wells, and to obtain visual images of a wellbore environment using said camera systems.

After said downhole camera system has been lowered within a wellbore and deployed to its intended location, in order to acquire a variety of visual images or other data by way of said downhole camera systems within an environment, light must be able to transmit through fluids in said environment. Fluids within such wellbores or other environments are typically conditioned and cleaned to provide improved operational characteristics. However, such conditioning and cleaning typically does not address the optical or light transmission qualities of the fluid. As such, even after cleaning and conditioning, conventional fluids in wellbores and the like typically render downhole visual inspection tools unfit for acquiring visual data.

Fluids with optically clear compositions currently exist for a variety of applications, including, without limitation, the function of carrying solids and wastes from oilfield environments for disposal or reclamation. Previously, however, these fluids have not been used for the purpose of creating a viewing window for diagnostic purposes.

Thus, there is a need for a method in which to visually examine a variety of areas of interest in oilfield environments generally comprising fluids of opaque or less than optically clear composition. Thus, the optically clear fluid, or gel, of the present invention is designed to displace opaque fluids, liquids, and gases, while maintaining a specific viscosity, weight, and other fluid properties in order to keep the opaque or less than optically clear fluids from encroaching into a viewing area, while visual data acquisition capture is underway.

### SUMMARY OF THE INVENTION

The present invention pertains to a novel method of use of an optically clear fluid that is placed strategically in localized area(s) of interest within wells or any other environment generally having opaque or non-transparent fluids in order to create a viewing window in which to capture visual diagnostic data.

In a preferred embodiment, the present invention comprises a means of specifically designing a fluid of optically clear composition by way of using a mixture of compounds in order to create a viewing window within a wellbore, pipeline, tank, vessel, or any other like environment. Said optically clear fluid is designed for the purpose of acquiring a plurality of visual images and/or other data of areas of interest in such environments, wherein said environments typically comprise opaque or less than optically clear fluids, such as, for example, drilling fluids, completion fluids, hydrocarbon gases, and/or other fluids of varied pressures and temperatures.

In a preferred embodiment, the present invention comprises positioning an optically clear fluid within a wellbore or tubular at a specific predetermined area of interest. This fluid may be preceded and or followed by fluids of different composition and density in order to maintain hydrostatic pressure control and retain the qualities that are needed in order to capture visual diagnostic data. Alternatively, the optically clear fluid may be preceded and or followed by a different substance, such as, for example, a composite, rubber, a deformable plug, a ball, or any other similar material exhibiting like characteristics in order to separate said optically clear fluid from any other indigenous well fluid.

### BRIEF DESCRIPTION OF THE DRAWINGS

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a side schematic view of a preferred embodiment of a typical oil and gas wellbore, wherein a diagnostic tool has been positioned within a strategically placed amount of optically clear fluid of the present invention at an area of interest within the wellbore.

FIG. 2 depicts a longitudinal-sectional view of an alternate embodiment of an oil and gas wellbore, wherein a diagnostic tool has been positioned within a strategically placed amount of optically clear fluid of the present invention at a particular area of interest within the wellbore in order to view a lost fish within said wellbore.

FIG. 3 depicts a longitudinal-sectional view of an alternate embodiment of an oil and gas wellbore, wherein a diagnostic tool has been positioned within a strategically placed amount of optically clear fluid of the present invention at a particular area of interest within the wellbore in order to inspect a liner top.

FIG. 4 depicts a longitudinal-sectional view of an alternate embodiment of an oil and gas wellbore, wherein a diagnostic tool has been positioned within a strategically placed amount of optically clear fluid of the present invention at a particular area of interest within the wellbore in order to inspect a blow out preventer.

### BEST MODES FOR CARRYING OUT THE INVENTION

The application on which this application claims priority, United States Provisional Patent Application No. 61/986,970, filed May 1, 2014, is incorporated herein by reference.

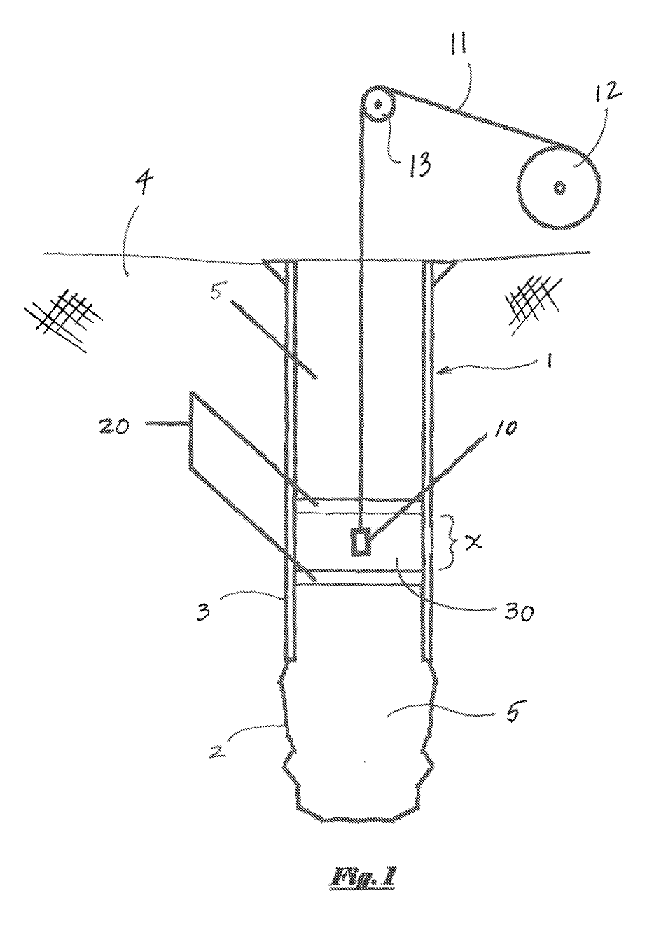

Referring to the drawings, FIG. 1 depicts a schematic view of a preferred embodiment of a wellbore 1 comprising open hole wellbore section 2 and cased section 3 extending into earths' crust 4. Wellbore 1 penetrates as least one subterranean formation. Sensor 10 is supported within wellbore 1; as depicted in FIG. 1, said sensor 10 is supported on wireline 11 which is spooled on drum 12 and disposed over sheave assembly 13.

By way of illustration, but not limitation, sensor 10 can comprise a camera (such as video or still image camera), diagnostic tool, or other device having a field of view or viewing area that can acquire, save and/or transmit data including, but not necessarily limited to, visual images. Although not depicted in FIG. 1, it is to be observed that sensor 10 could alternatively be conveyed in wellbore 1 via a pipe string, such as a jointed pipe or continuous tubing or the like, without departing from the scope of the present invention.

Still referring to FIG. 1, drilling fluid 5 is disposed within wellbore 1. Said drilling fluid can comprise drilling mud containing clays (such as, for example, bentonite), solids, weighting materials, chemicals, additives, well fluids and/or other materials. Additionally, hydrocarbons or other non-transparent fluids produced from subterranean formations penetrated from said wellbore can also be contained within said wellbore. Further, as depicted in FIG. 1, said drilling fluid 5 can comprise opaque or non-transparent material that generally cannot be seen through and substantially prevents the transmission of light within wellbore 1.

As depicted in FIG. 1, in a preferred embodiment, downhole sensor 10 is axially lowered into wellbore 1 and positioned at a particular area of interest or a desired location within said wellbore 1. A predetermined volume of fluid spacer 20, that is beneficially designed to retain desired properties of an optically clear or substantially transparent fluid 30, is pumped or otherwise introduced into wellbore 1. Thereafter, a predetermined volume of optically clear fluid 30 is pumped or introduced into wellbore 1, followed by an additional predetermined volume of spacer fluid 20. If desired, said optically clear fluid and spacer fluid(s) can be displaced (typically by pumping an additional volume of drilling fluid 5) until said optically clear fluid is positioned at a desired location in said wellbore 1.

In this manner, a desired volume of optically clear or substantially transparent fluid 30 is bracketed (above and below), held together, isolated and/or maintained as a substantially consistent and coherent section by fluid spacer 20. As such, said optically clear fluid 30 is substantially segregated and/or isolated from other opaque fluid in said wellbore. Further, said optically clear fluid 30 is strategically positioned within wellbore 1 substantially solely at desired area(s) of interest “x” within wellbore 1 in order to create a localized environment in said sensor 10 can acquire visual data or otherwise operate in accordance with its desired purpose.

It is to be observed that desired volumes of spacer fluid 20 and optically clear fluid 30 can be determined based upon calculated capacities of wellbore 1 and/or any pipe disposed in said wellbore 1. Put another way, the desired vertical column heights of said spacer fluid 20 and optically clear fluid 30 can be calculated based upon said wellbore/pipe capacities and volumes of said fluids pumped or otherwise introduced in said wellbore and/or pipe, and can be displaced with calculated volumes of drilling or other fluid.

In a preferred embodiment, optically clear fluid 30 of the present invention generally comprises a Poly Acrylic Acid 18-40%, Raffinates (petroleum) Solvent 50-70% concentration by weight; however, optically clear fluid 30 can comprise any other material or composition exhibiting desired characteristics. Viscosity, specific gravity and/or other characteristics of said optically clear fluid 30 can likewise be varied to satisfy particular operational requirements and job parameters. In many cases, said optically clear fluid 30 will comprise a gel, or will otherwise exhibit gel-like characteristics.

Still referring to FIG. 1, in a preferred embodiment, a column of opaque fluid 5 is depicted as being disposed above area of interest with sensor or diagnostic tool 10 and optically clear fluid 30, but is preceded and followed by fluid spacer 20 that is designed to retain the different properties of the optically clear fluid 30 (including, without limitation, by isolating said optically clear fluid 30 from opaque fluid 5). As a result, this chain of fluid layering and arrangement creates a plurality of liquid barriers on both sides of optically clear fluid 30 in order to maintain the beneficial qualities and characteristics of said optically clear fluid 30. In this manner, only a relatively limited volume of optically clear fluid 30 is used in a particular localized area of interest, and thus, there is no need to flush or replace all indigenous fluid, or fluid that is generally within a system (such as, for example, opaque fluid 5), with such optically clear fluid 30.

In a preferred embodiment, the chain of fluid depicted in FIG. 1 including, without limitation, optically clear fluid 30, can be displaced from wellbore 1 upon completing a diagnostic acquisition of the desired data or other information using sensor 10. Thereafter, an entire wellbore environment can be filled with opaque fluid 5 or any other such fluid as may be desired for operational concerns or any other reasons.

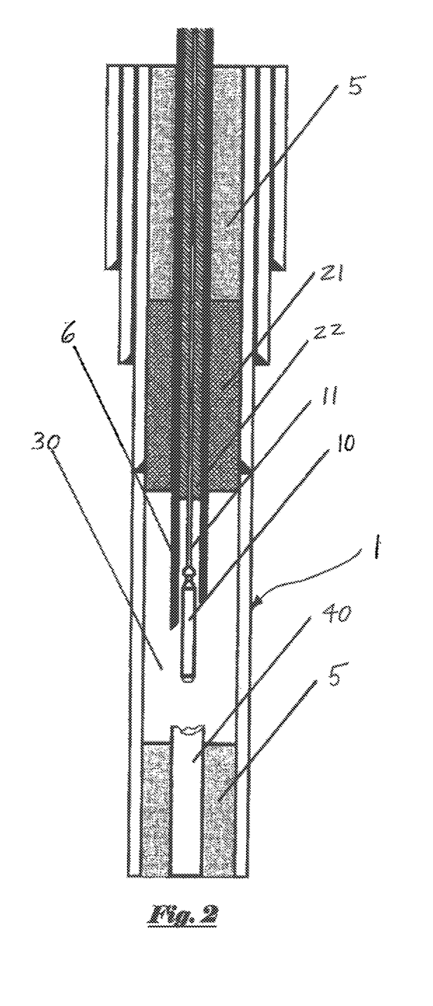

FIG. 2 depicts a longitudinal sectional view of an alternate embodiment of a strategically placed optically clear fluid 30 of the present invention surrounding a sensor 10 (such as a diagnostic tool) located within a conventional wellbore 1 that is being used to obtain data regarding a fish 40 that has been lost downhole within a wellbore.

As depicted in FIG. 2, in an alternate embodiment, a downhole sensor 10 (such as, for example, a camera or a diagnostic tool), is generally axially lowered into wellbore 1 via wireline 11 through a pipe string 6; pipe string 6 can comprise a length or drill pipe or tubular workstring disposed in wellbore 1. Sensor 10 is positioned at particular area of interest or a desired location within wellbore 1 in order to view and obtain data regarding a fish 40 that has been lost downhole within said wellbore 1.

Sensor 10 is partially exposed and extended outside of the lower or distal end of pipe string 6, and thus, has a relatively larger surrounding view of an area of interest in order to locate and view lost fish 40. Optically clear fluid 30 is strategically positioned within wellbore 1 solely at a desired area of interest; as depicted in FIG. 2, said optically clear fluid 30 is disposed at or near the vicinity of fish 40, in order to create a localized environment in which said sensor 10 can operate and perform desired functions (such as, for example, acquiring visual data regarding fish 40 or portions thereof).

As illustrated in FIG. 2, a column (or desired volume) of weighted fluid spacer 21 that is designed to retain the different properties of optically clear fluid 30 is positioned above an area of interest containing optically clear fluid 30. In order to properly place weighted fluid spacer 21 within said wellbore 1, weighted fluid spacer 21 can be pumped or otherwise introduced through pipe string 5, and is generally followed by high viscosity spacer fluid 22. High viscosity spacer 6 (such as, for example hydroethylcellulose (HEC) or any other similar polymer exhibiting like characteristics) generally comprises a variety of different properties compared to any other fluid within the wellbore 1. As a result, this chain of fluid layering and arrangement creates a liquid barrier above optically clear fluid 30 in order to substantially isolate and maintain the properties of optically clear fluid 30.

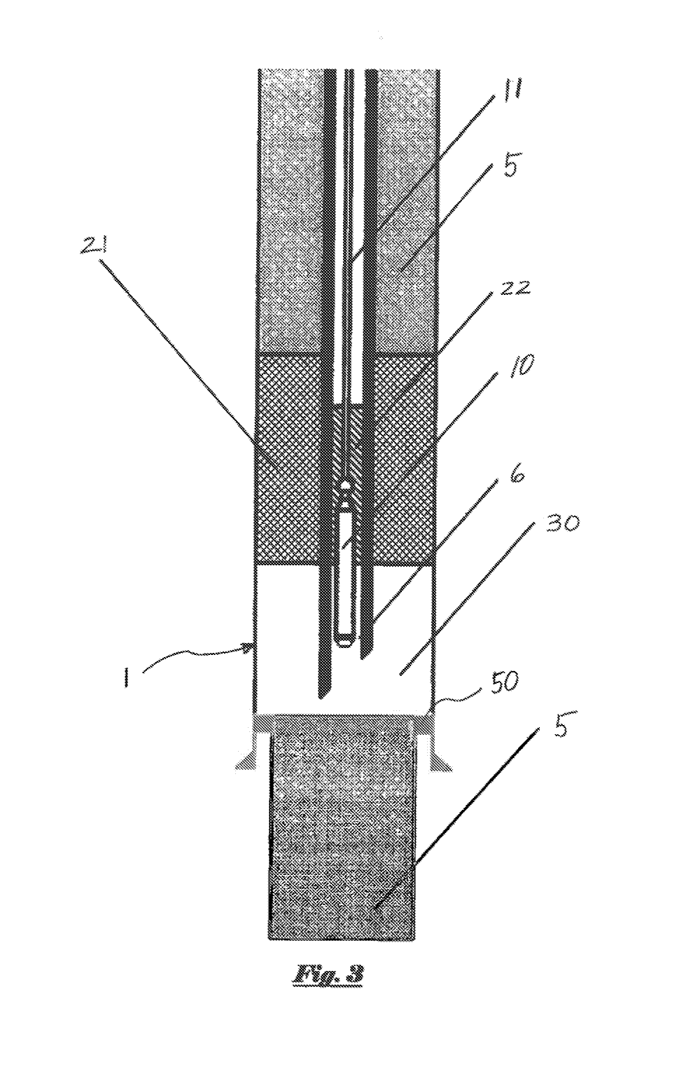

FIG. 3 depicts a longitudinal sectional view of an alternate embodiment of a strategically placed optically clear fluid 30 of the present invention surrounding or in proximity to a sensor 10 (such as a diagnostic tool) located within a conventional wellbore 1 that is being used to obtain data regarding a liner top 50 within a wellbore 1. As depicted in FIG. 3, in an alternate embodiment, a downhole sensor 10 (such as, for example, a camera or a diagnostic tool), is generally axially lowered into wellbore 1 via wireline 11 through a pipe string 6; pipe string 6 can comprise a length or drill pipe or tubular workstring disposed in wellbore 1. Sensor 10 is positioned at particular area of interest or a desired location within wellbore 1 in order to view and obtain data regarding liner top 50 within said wellbore 1.

Sensor 10 remains fully received within pipe string 6 while inspecting said liner top 50 in order to obtain an “overhead” or top view of said liner top 50. Therefore, a view of sensor 10 will not be compromised by any other item or substance that may be located within said area of interest. Optically clear fluid 30 is positioned within the wellbore solely at the area of interest for viewing liner top 30 in order to create a localized environment in which sensor 10 can operate and perform desired functions (such as, for example, acquiring visual data regarding liner top 50 or portions thereof).

A column of weighted fluid spacer 21 that is designed to retain the different properties of optically clear fluid 30 is then positioned above the column of optically clear fluid 30 by way of high viscosity spacer 22. Thus, this chain or staggering of fluid layering and arrangement creates a plurality of liquid barriers for optically clear fluid 30 in order to isolate such fluid and maintain the qualities of said optically clear fluid 30.

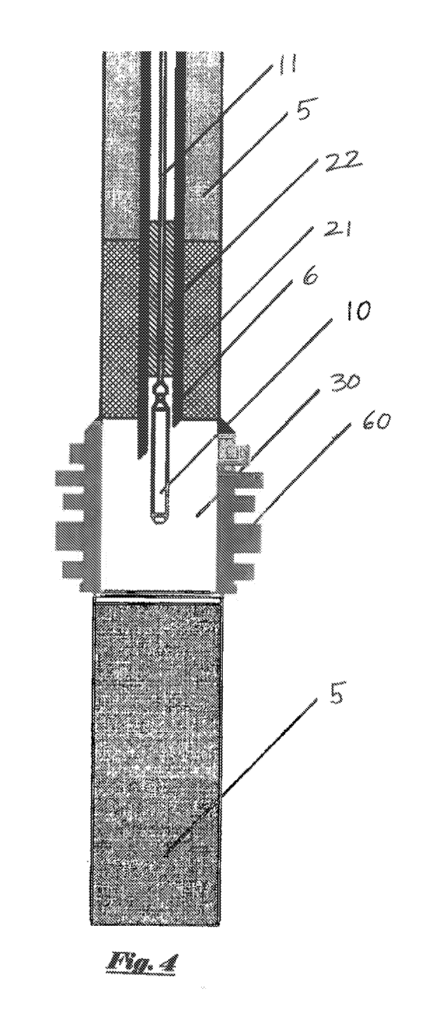

FIG. 4 depicts a longitudinal sectional view of an alternate embodiment of a strategically placed optically clear fluid 30 of the present invention surrounding or in the vicinity of a sensor 10 (such as a diagnostic tool) located within a conventional wellbore 1 that is being used to obtain data regarding a blowout preventer assembly 60 installed in connection with a wellbore.

As depicted in FIG. 4, in an alternate embodiment, a downhole sensor 10 (such as, for example, a camera or a diagnostic tool), is generally axially lowered into wellbore 1 via wireline 11 through a pipe string 6; pipe string 6 can comprise a length or drill pipe or tubular workstring disposed in wellbore 1. Sensor 10 is positioned at particular area of interest or a desired location within wellbore 1 in order to view and obtain data regarding blowout preventer assembly 60 that is installed on wellbore 1.

Sensor 10 is partially exposed and extended outside of the lower or distal end of pipe string 6, and thus, has a relatively larger surrounding view of an area of interest in order to locate and view blowout preventer assembly 60 including, without limitation, internal surfaces or components thereof (such as, for example, ram bodies). Optically clear fluid 30 is strategically positioned within wellbore 1 solely at a desired area of interest; as depicted in FIG. 4, said optically clear fluid 30 is disposed at or near the vicinity of blowout preventer 60, in order to create a localized environment in which said sensor 10 can operate and perform desired functions (such as, for example, acquiring visual data regarding blowout preventer assembly 60 or portions thereof).

As illustrated in FIG. 4, a column (or desired volume) of weighted fluid spacer 21 that is designed to retain the different properties of optically clear fluid 30 is positioned above an area of interest containing optically clear fluid 30. In order to properly place weighted fluid spacer 21 within said wellbore 1, weighted fluid spacer 21 can be pumped or otherwise introduced through pipe string 5, and is generally followed by high viscosity spacer fluid 22. High viscosity spacer 22 (such as, for example hydroethylcellulose (HEC) or any other similar polymer exhibiting like characteristics) generally comprises a variety of different properties compared to any other fluid within the wellbore 1. As a result, this chain of fluid layering and arrangement creates a liquid barrier above optically clear fluid 30 in order to substantially isolate and maintain the properties of optically clear fluid 30.

Although not depicted in FIGS. 1 through 4, in an alternate embodiment, a different substance, such as, for example, a composite, rubber, a deformable plug, a ball, or any other alternative material exhibiting desired characteristics may be used to separate optically clear fluid 30 from opaque fluid 5 instead of said fluid spacer 20 shown in the attached drawings.

Moreover, although not depicted in FIGS. 1 through 4, in an additional alternate embodiment, the method of the present invention can be utilized when a sensor, camera or diagnostic tool is not conveyed in a well via electric line or slickline. By way of illustration, but not limitation, optically clear fluid 30 can be used to provide an improved wellbore environment for acquiring visual images or other data even when such sensor(s), camera(s) and/or diagnostic tool(s) are conveyed into a wellbore via drill pipe, workstring and/or or other tubular goods.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

1. A method of acquiring visual images or other data from an environment containing opaque fluid comprising:
a) conveying a sensor having a field of view into said environment;
b) introducing a substantially clear fluid into said environment, wherein said substantially clear fluid is disposed within said field of view.

2. The method of claim 1, wherein said substantially clear fluid in said environment is substantially limited to said field of view.

3. The method of claim 1, further comprising introducing at least one barrier between said substantially clear fluid and said opaque fluid.

4. The method of claim 3, wherein said at least one barrier comprises at least one solid object substantially constructed of a synthetic composite or rubber material.

5. The method of claim 4, wherein said at least one solid object comprises a deformable object, plug or ball.

6. The method of claim 3, wherein said at least one barrier comprises a spacer fluid adapted to isolate said substantially clear fluid from said opaque fluid.

7. The method of claim 1, wherein said optically clear fluid comprises:
a) Poly Acrylic Acid 18 to 40% concentration by weight; and
b) Raffinates (petroleum) Solvent 50 to 70% concentration by weight.

8. The method of claim 1, wherein said environment comprises a wellbore penetrating at least one subterranean formation.

9. The method of claim 6, wherein said opaque fluid comprises drilling fluid.

10. The method of claim 9, wherein said opaque fluid comprises fluid produced from said at least one subterranean formation.

11. A method of acquiring visual images from a wellbore penetrating at least one subterranean formation, wherein said wellbore contains opaque fluid, comprising:
a) conveying a camera having a field of view into said wellbore;
b) introducing optically clear fluid into said wellbore, wherein said optically clear fluid is disposed substantially only within said field of view.

12. The method of claim 11, further comprising introducing at least one barrier between said optically clear fluid and said opaque fluid.

13. The method of claim 12, wherein said at least one barrier comprises at least one spacer fluid adapted to isolate said optically clear fluid from said opaque fluid.

14. The method of claim 13, further comprising:
a) pumping a predetermined first volume of said at least one spacer fluid in said wellbore;
b) pumping a predetermined volume of said optically clear fluid in said wellbore;
c) pumping a predetermined second volume of said at least one spacer fluid in said wellbore; and
d) displacing said first volume of spacer fluid, said optically clear fluid and said second volume of spacer fluid until said optically clear fluid is positioned substantially within said field of view.

15. The method of claim 13, wherein the viscosity of said spacer fluid is greater than the viscosity of said opaque fluid.

16. The method of claim 12, wherein said at least one barrier comprises at least one solid object substantially constructed of a synthetic composite or rubber material.

17. The method of claim 16, wherein said at least one solid object comprises a deformable object, plug or ball.

18. The method of claim 11, wherein said optically clear fluid comprises:
c) Poly Acrylic Acid 18 to 40% concentration by weight; and
d) Raffinates (petroleum) Solvent 50 to 70% concentration by weight.

19. The method of claim 11, wherein said opaque fluid comprises drilling fluid.

20. The method of claim 11, wherein said opaque fluid comprises fluid produced from said at least one subterranean formation.
